(19) United States
(12) Patent Application Publication
(10) Pub. No.: US 2016/0179432 A1
(43) Pub. Date: Jun. 23, 2016

(54) INFORMATION PROCESSING APPARATUS AND MEMORY MANAGEMENT METHOD

(71) Applicant: FUJITSU LIMITED, Kawasaki-shi (JP)

(72) Inventors: Hideyuki Niwa, Numazu (JP); Yasuo Koike, Numazu (JP); Kazuhisa Fujita, Fuji (JP); TOSHIYUKI MAEDA, Suntou (JP); Tadahiro Miyaji, Nagoya (JP); Tomonori Furuta, Nagoya (JP); Fumiaki ITOU, Kasugai (JP); Isao Nunoichi, Nakaokubo (JP)

(73) Assignee: FUJITSU LIMITED, Kawasaki-shi (JP)

(21) Appl. No.: 14/932,106

(22) Filed: Nov. 4, 2015

(30) Foreign Application Priority Data
Dec. 17, 2014 (JP) 2014-255125

(51) Int. Cl. G06F 3/06

(52) U.S. Cl. CPC G06F 3/0638; G06F 3/0604; G06F 3/0664; G06F 3/0683

(57) ABSTRACT

Each of a plurality of, as many as three or more, processes is executed by one of a first virtual machine and a second virtual machine, and each of the first and second virtual machines executes at least one of the processes. At the execution of each of the processes, a virtual memory unit corresponding to the process is referred to. Based on ranks each assigned in advance to one of the processes, a processor changes an assignment destination of a physical memory area currently assigned to each of virtual memory units, except for a virtual memory unit corresponding to a last-rank process, to a virtual memory unit corresponding to a next-rank process following a process corresponding to a virtual memory unit to which the physical memory area is currently assigned.

### CROSS-REFERENCE TO RELATED APPLICATION

This application is based upon and claims the benefit of priority of the prior Japanese Patent Application No. 2014-255125, filed on Dec. 17, 2014, the entire contents of which are incorporated herein by reference.

### FIELD

The embodiments discussed herein are related to an information processing apparatus and a memory management method.

### BACKGROUND

In late years, the volume of data to be stored in a storage apparatus goes on increasing, and in keeping with this trend, it is sought to renovate old storage systems and establish new storage systems. However, products included in conventional storage systems have different access schemes, data operation methods and the like depending on the intended use, and there has therefore been a need to establish a storage system using different products for each intended use. For example, storage controllers for controlling access to storage apparatuses have different access schemes. Specifically, some storage controllers receive requests for block-based access, but others receive requests for file-based access.

In view of the above-described circumstances, products called “unified storage” that supports a plurality of access schemes have emerged. A storage controller applied to a unified storage system is able to, for example, control access to a storage apparatus in response to a block-based access request, as well as in response to a file-based access request. Thus, the unified storage is allowed to be installed on systems with a wide range of uses irrespective of access schemes, which holds promise for reducing operational costs through storage consolidation.

On the other hand, virtualization technology has been in widespread use that runs a plurality of virtual machines on a single computer. In this connection, memory management methods for a situation where a plurality of virtual machines are running include the following. For example, an apparatus has been proposed which includes virtual machine control logic configured to transfer control of the apparatus among a host and a plurality of guests; an execution unit configured to execute an instruction to copy information to a first virtual memory address in a first guest from a second virtual memory address in a second guest; and a memory management unit configured to translate the first virtual memory address to a first physical memory address and to translate the second virtual memory address to a second physical memory address. Another proposed technique is directed to a method of using a transfer mechanism enabling information transfer between a first partition and a second partition by using at least one of (a) a ring buffer and (b) either transfer pages or address space manipulation.

Japanese National Publication of International Patent Application No. 2010-503115

Japanese Laid-open Patent Publication No. 2006-318441

A storage controller applied to a unified storage system may be implemented, for example, by executing an access control process according to a block-based access request on one virtual machine and executing an access control process according to a file-based access request on a different virtual machine. A method possibly adopted in this case is to execute, via one of the virtual machines, an access control process of controlling access to a storage apparatus according to an access request received by the other virtual machine.

However, this method involves the execution of a number of processes, such as data passing between the virtual machines and conversion of the data being passed from one type of access unit to the other type of access unit, before the access is made to the storage apparatus. In addition, the execution of each process involves copying processed data to a memory area to which the next process refers. Entailing such a large number of copy processes increases the processing load on a processor, which results in a decrease in the response performance to access requests from host apparatuses.

The problem of a large number of copy processes does not apply only to the above-described storage controller, but also to the case where data is passed through many processes in an environment with a plurality of virtual machines operating.

### SUMMARY

According to an aspect, there is provided an information processing apparatus on which a plurality of virtual machines run. The information processing apparatus includes a memory and a processor. The memory stores address information registering therein mappings between addresses of a plurality of virtual memory units individually referred to at execution of each of a plurality of, as many as three or more, processes and addresses of a plurality of physical memory areas each of which is assigned to one of the virtual memory units. The processor performs a procedure including running a first virtual machine and a second virtual machine; causing, in a condition where each of the physical memory areas is assigned to one of the virtual memory units based on the address information, each of the processes to be executed in parallel on one of the first virtual machine and the second virtual machine, the first virtual machine being caused to execute at least one of the processes and the second virtual machine being caused to execute at least another one of the processes; and updating, based on ranks each assigned in advance to one of the processes, the address information in such a manner that an assignment destination of each of the physical memory areas currently assigned to one of the virtual memory units, except for a virtual memory unit corresponding to a last-rank process, is changed to a virtual memory unit corresponding to a next-rank process following a process corresponding to the virtual memory unit to which the physical memory area is currently assigned.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration and processing example of an information processing apparatus according to a first embodiment;

FIG. 2 illustrates a configuration example of a storage system according to a second embodiment;

FIG. 3 is a block diagram illustrating a configuration example of processing functions of a controller module;

FIG. 4 illustrates a comparative example of a procedure performed in response to a request for file-based write access;

FIG. 5 illustrates a comparative example of a procedure performed in response to a request for file-based read access;

FIG. 6 illustrates an operation example of data passing through applications, performed in response to a request for file-based write access;

FIG. 7 illustrates an operation example of data passing through the applications, performed in response to a request for file-based read access;

FIG. 8 illustrates an example of a data structure of an address conversion table;

FIG. 9 illustrates a first part of an example of updating the address conversion table in write access;

FIG. 10 illustrates a second part of the example of updating the address conversion table in the write access;

FIG. 11 illustrates an example of a mechanism for each application to notify a memory control unit of processing completion;

FIG. 12 is a flowchart illustrating an example of a processing procedure of each application;

FIG. 13 illustrates an example of a processing procedure of the memory control unit upon receiving an attaching request;

FIG. 14 illustrates an example of a processing procedure of the memory control unit, associated with the execution of data processing by applications;

FIG. 15 illustrates an example of a processing procedure of the memory control unit upon receiving a detaching request; and

FIG. 16 illustrates an operation example of changing assignment of physical memory areas according to a modification.

### DESCRIPTION OF EMBODIMENTS

Several embodiments will be described below with reference to the accompanying drawings, wherein like reference numerals refer to like elements throughout.

### (a) First Embodiment

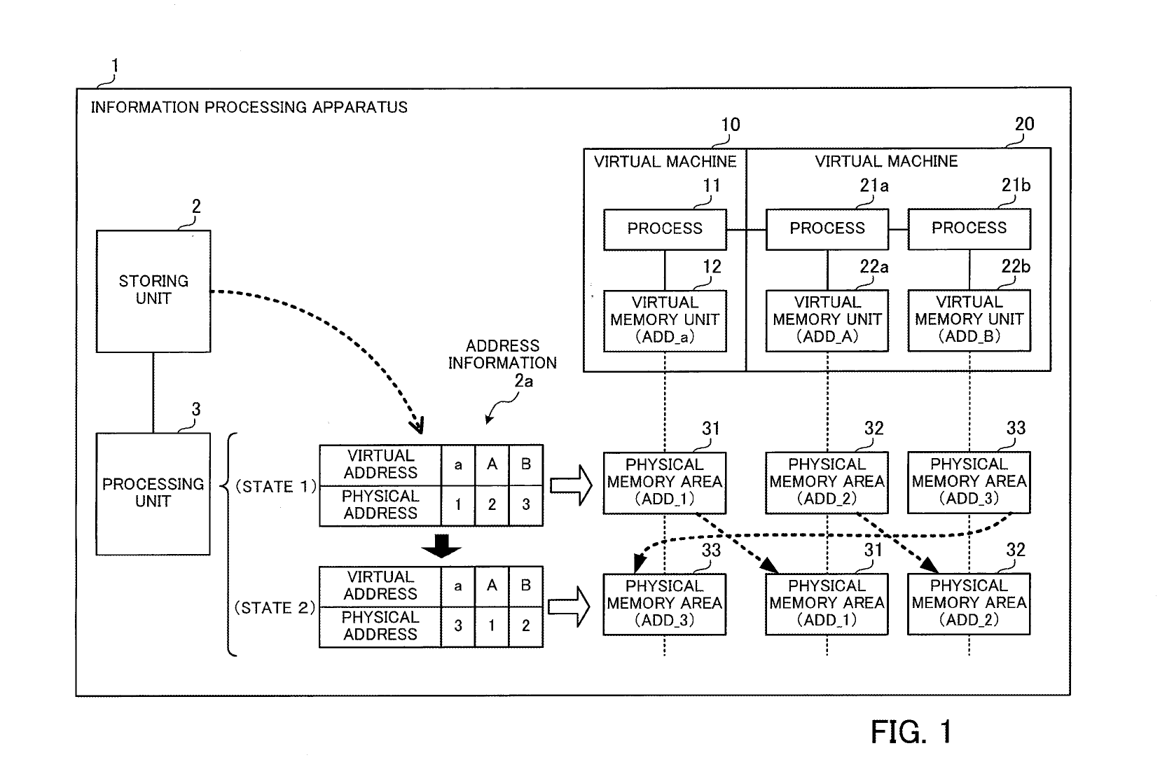

FIG. 1 illustrates a configuration and processing example of an information processing apparatus according to a first embodiment. On an information processing apparatus 1, virtual machines 10 and 20 are running. In addition, the information processing apparatus 1 deals with the execution of a plurality of, as many as three or more, processes. Each process is executed by either one of the virtual machines 10 and 20. In addition, at least one of the processes is executed by the virtual machine 10, and at least another one of the processes is executed by the virtual machine 20. Furthermore, the plurality of processes are executed in parallel. According to the example of FIG. 1, the virtual machine 10 executes a process 11, and the virtual machine 20 executes processes 21a and 21b.

Note that each of the processes 11, 21a, and 21b is executed according to a different application program. In this regard, for example, the application program implementing the process 11 is executed under a virtual operating system (OS) running in the virtual machine 10. Similarly, the application programs individually implementing the processes 21a and 21b are executed under a virtual operating system running in the virtual machine 20.

The processes 11, 21a, and 21b are assigned virtual memory units 12, 22a, and 22b, respectively. The virtual memory unit 12 is a memory area mapped in a virtual memory space of the virtual machine 10. The process 11 executes a predetermined procedure using the virtual memory unit 12. The virtual memory units 22a and 22b are individual memory areas mapped in a virtual memory space of the virtual machine 20. The process 21a executes a predetermined procedure using the virtual memory unit 22a. The process 21b executes a predetermined procedure using the virtual memory unit 22b. Assume here that the individual virtual memory units 12, 22a, and 22b have the same capacity.

Each of the processes 11, 21a, and 21b is assigned a rank in advance. The ranks represent the sequence of data passing. According to the example of FIG. 1, the processes 11, 21a, and 21b are assigned a rank in the stated order, and data is sequentially passed from the process 11 to the process 21a, and then to the process 21b. Specifically, processed data obtained from the process 11 is transferred from the virtual memory unit 12 to the virtual memory unit 22a. With this, the processed data is passed from the process 11 to the process 21a. Similarly, processed data obtained from the process 21a is transferred from the virtual memory unit 22a to the virtual memory unit 22b. With this, the processed data is passed from the process 21a to the process 21b.

According to the information processing apparatus 1, data passing among the processes is implemented by a procedure described below, without substantial data transfer from the virtual memory unit 12 to the virtual memory unit 22a and from the virtual memory unit 22a to the virtual memory unit 22b. The information processing apparatus 1 includes a storing unit 2 and a processing unit 3. The storing unit 2 is implemented using, for example, a storage area of a storage device such as random access memory (RAM). The processing unit 3 is implemented using, for example, a processor such as a central processing unit (CPU) or a micro processing unit (MPU).

The storing unit 2 stores therein address information 2a. The address information 2a registers therein mappings between virtual addresses of the virtual memory units 12, 22a, and 22b and physical addresses of physical memory areas individually assigned to the virtual memory units 12, 22a, and 22b. Note that each address registered in the address information 2a is, for example, the beginning address of its corresponding memory unit/area. Note that, in FIG. 1, an address X is denoted as “ADD_X”. For example, the virtual address of the virtual memory unit 12 is ADD_a, and the virtual addresses of the virtual memory units 22a and 22b are ADD_A and ADD_B, respectively. Note however that, within the address information 2a illustrated in FIG. 1, the notation of “ADD_” is omitted for the sake of brevity.

The processing unit 3 controls assignment of the physical memory areas to the individual virtual memory units 12, 22a, and 22b. For example, in State 1 of FIG. 1, the processing unit 3 secures physical memory areas 31 to 33. Assume that the physical address of the physical memory area 31 is ADD_1; the physical address of the physical memory area 32 is ADD_2; and the physical address of the physical memory area 33 is ADD_3. In State 1, the processing unit 3 assigns the physical memory areas 31, 32, and 33 to the virtual memory units 12, 22a, and 22b, respectively. In this state, each of the processes 11, 21a, and 21b executes its procedure in parallel, using its associated virtual memory unit. In reality, the processes 11, 21a, and 21b execute their procedures using the physical memory areas 31, 32, and 33, respectively. As a result, processed data obtained from each of the processes 11, 21a, and 21b is individually stored in the physical memory areas 31, 32, and 33.

Next, the processing unit 3 updates the address information 2a in such a manner that the physical memory areas assigned to the virtual memory units 12, 22a, and 22b are changed as follows. As for the physical memory areas 31 and 32 currently assigned to the virtual memory units 12 and 22a, other than the virtual memory unit 22b associated with the last-rank process 21b, the processing unit 3 changes the assignment destination of each of the physical memory areas 31 and 32 to a virtual memory unit associated with the next-rank process following the process corresponding to its currently assigned virtual memory unit. With this, as illustrated in State 2 of FIG. 1, the assignment destination of the physical memory area 31 is changed from the virtual memory unit 12 to the virtual memory unit 22a, and the assignment destination of the physical memory area 32 is changed from the virtual memory unit 22a to the virtual memory area 22b.

With the changes in the assignment destinations, the processed data of the process 11, stored in the virtual memory unit 12, is moved to the virtual memory unit 22a, and the processed data of the process 21a, stored in the virtual memory unit 22a, is moved to the virtual memory unit 22b. That is, the processed data obtained from the process 11 is passed to the process 21a without substantial data transfer. Similarly, the processed data obtained from the process 21a is passed to the process 21b without substantial data transfer.

As a result, it is possible to reduce the processing load on the information processing apparatus 1, associated with data passing among the plurality of processes. In addition, because the physical memory areas assigned to the plurality of virtual memory units are reassigned all at once, the processing load accompanying the data passing among the plurality of processes is reduced while maintaining processing parallelism among the processes. Note that, in State 2, the physical memory area 33 or a newly secured physical memory area is assigned to the virtual memory unit 12.

### (b) Second Embodiment

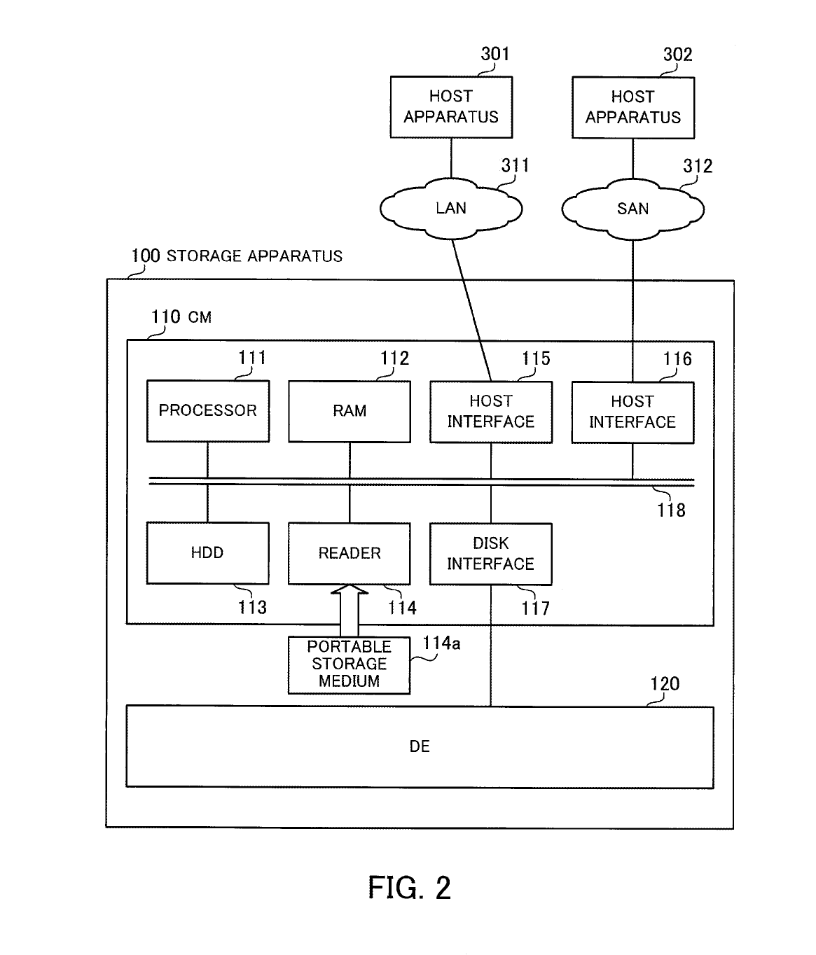

The second embodiment is directed to a storage system provided with the information processing apparatus of the first embodiment. FIG. 2 illustrates a configuration example of a storage system according to the second embodiment. The storage system of FIG. 2 includes a storage apparatus 100 and host apparatuses 301 and 302. The host apparatus 301 is connected to the storage apparatus 100, for example, via a local area network (LAN) 311. The host apparatus 302 is connected to the storage apparatus 100, for example, via a storage area network (SAN) 312. The host apparatus 301 requests the storage apparatus 100 for access to a storage unit in the storage apparatus 100. Similarly, the host apparatus 302 requests the storage apparatus 100 for access to the storage unit of the storage apparatus 100.

The storage apparatus 100 includes a controller module (CM) 110 and a drive enclosure (DE) 120. The drive enclosure 120 is the storage unit to be accessed from the host apparatuses 301 and 302. The drive enclosure 120 houses a plurality of hard disk drives (HDDs) as storage devices making up the storage unit. Note that the drive enclosure 120 may be provided external to the storage apparatus 100. The storage devices making up the storage unit are not limited to HDDs but may be, for example, other kinds of storage devices, such as solid state drives (SSDs).

The controller module 110 is an example of the information processing apparatus 1 illustrated in FIG. 1. The controller module 110 is a storage control unit for controlling access to the storage unit. That is, in response to each access request from the host apparatus 301 or 302, the controller module 110 controls access to a HDD in the drive enclosure 120. For example, upon receiving a request to read data stored in a HDD of the drive enclosure 120 from the host apparatus 301, the controller module 110 reads the requested data from the HDD in the drive enclosure 120 and then transmits the read data to the host apparatus 301. In addition, upon receiving a request to write data to a HDD in the drive enclosure 120 from the host apparatus 301, the controller module 110 writes the requested data to the HDD in the drive enclosure 120.

The controller module 110 includes a processor 111, RAM 112, a HDD 113, a reader 114, host interfaces 115 and 116, and a disk interface 117. Overall control of the controller module 110 is exercised by the processor 111. The RAM 112 is used as a main memory device of the controller module 110, and temporarily stores therein at least part of programs to be executed by the processor 111 and various types of data to be used in the processing of the programs. In addition, the RAM 112 is also used as a cache area for caching data stored in HDDs of the drive enclosure 120.

The HDD 113 is used as a secondary memory device of the controller module 110, and stores therein programs to be executed by the processor 111 and various types of data needed for the processor 111 to execute the programs. Note that, as a secondary memory device, a different type of non-volatile memory device, such as a SSD, may be used in place of the HDD 113. On the reader 114, a portable storage medium 114a is loaded. The reader 114 reads data recorded on the storage medium 114a and transmits the read data to the processor 111. The storage medium 114a may be an optical disk, a magneto optical disk, or a semiconductor memory, for example.

The host interface 115 is connected to the host apparatus 301 via the LAN 311, and performs interface processing of transmitting and receiving data between the host apparatus 301 and the processor 111. The host interface 116 is connected to the host apparatus 302 via the SAN 312, and performs interface processing of transmitting and receiving data between the host apparatus 302 and the processor 111. The disk interface 117 is connected to the drive enclosure 120, and performs interface processing of transmitting and receiving data between each HDD in the drive enclosure 120 and the processor 111.

In the above-described storage system, the host apparatus 302 requests the controller module 110 for block-based access. For example, the host apparatus 302 communicates with the controller module 110 using a communication protocol, such as Fibre Channel (FC), FC over Ethernet (FCoE, “Ethernet” is a registered trademark), or Small Computer System Interface (iSCSI). On the other hand, the host apparatus 301 requests the controller module 110 for file-based access. For example, the host apparatus 301 communicates with the controller module 110 using a communication protocol, such as Network File System (NFS) or Common Internet File System (CIFS).

The storage apparatus 100 operates as unified storage supporting two communication protocols with different data access units. The controller module 110 has both a processing function of controlling access to the drive enclosure 120 in response to a block-based access request and a processing function of controlling access to the drive enclosure 120 in response to a file-based access request. The controller module 110 implements each of these two processing functions by running an application program on an individual virtual machine.

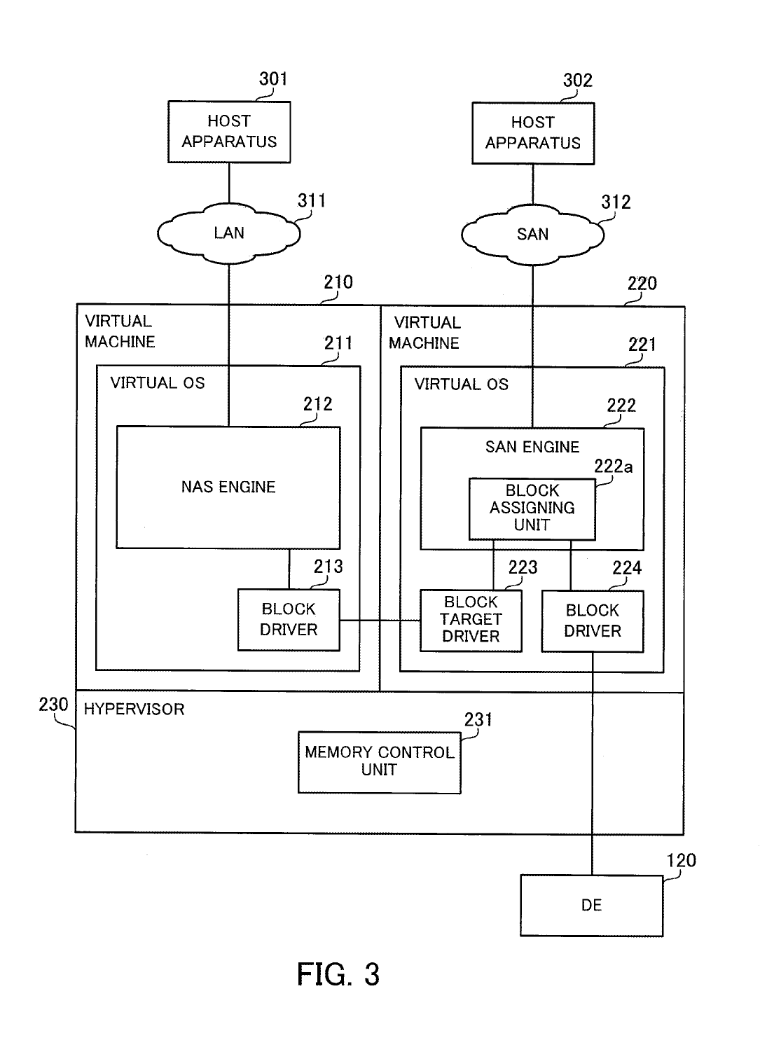

FIG. 3 is a block diagram illustrating a configuration example of processing functions of the controller module. Virtual machines 210 and 220 are hosted on the controller module 110. The virtual machine 210 is connected to the host apparatus 301 via the LAN 311, and implements a processing function of controlling access to the drive enclosure 120 in response to a file-based access request from the host apparatus 301. On the other hand, the virtual machine 220 is connected to the host apparatus 302 via the SAN 312, and implements a processing function of controlling access to the drive enclosure 120 in response to a block-based access request from the host apparatus 302.

In addition, the controller module 110 includes a hypervisor 230. Processing of the hypervisor 230 is implemented by the processor 111 of the controller module 110 running a hypervisor program. The hypervisor 230 creates the virtual machines 210 and 220 and manages their operations. In addition, the hypervisor 230 manages physical resources assigned to the virtual machines 210 and 220. The hypervisor 230 includes a memory control unit 231 that serves as one function of managing the physical resources. The memory control unit 231 manages the assignment of physical memory areas to a plurality of particular application programs (to be described later) running on the virtual machines 210 and 220.

In addition, the controller module 110 includes, as processing functions implemented on the virtual machine 210, a virtual operating system (OS) 211, a network attached storage (NAS) engine 212, and a block driver 213. The controller module 110 includes, as processing functions implemented on the virtual machine 220, a virtual operating system (OS) 221, a SAN engine 222, a block target driver 223, and a block driver 224.

Processing of the virtual operating system 211 is implemented by the virtual machine 210 running an operating system program. Processing of each of the NAS engine 212 and the block driver 213 is implemented by the virtual machine 210 running an individually predetermined application program on the virtual operating system 211. The NAS engine 212 implements processing of running the storage apparatus 100 as NAS. That is, the NAS engine 212 controls access to the drive enclosure 120 in response to a file-based access request from the host apparatus 301. The block driver 213 reads and writes data from and to the storage unit in response to requests from the NAS engine 212. In the case of implementing the NAS engine 212 on an actual machine, the block driver 213 transmits and receives read data and data to be written to and from the actual storage unit, that is, the drive enclosure 120. However, according to this embodiment, the NAS engine 212 is implemented on the virtual machine 210. In this case, the block driver 213 transmits and receives read data and data to be written to and from the block target driver 223 running on the virtual machine 220, in place of the drive enclosure 120. In this manner, upon receiving an access request from the host apparatus 301, the virtual machine 210 accesses the drive enclosure 120 via the virtual machine 220.

On the other hand, processing of the virtual operating system 221 is implemented by the virtual machine 220 running an operating system program. Processing of each of the SAN engine 222, the block target driver 223, and the block driver 224 is implemented by the virtual machine 220 running an individually predetermined application program on the virtual operating system 221. The SAN engine 222 controls access to the drive enclosure 120 in response to a block-based access request from the host apparatus 302. The SAN engine 222 includes a block assigning unit 222a. The block assigning unit 222a mutually converts between access-unit blocks used when access is made to the drive enclosure 120 through the NAS engine 212 and access-unit blocks used when access is made to the drive enclosure 120 through the SAN engine 222. In the following description, the former is sometimes referred to as “NAS blocks” and the latter is sometimes referred to as “SAN blocks”. Note that the block assigning unit 222a may be implemented by running an application program different from the SAN engine program implementing the SAN engine 222.

The block target driver 223 transfers NAS blocks between the block driver 213 and the block assigning unit 222a. The block driver 224 accesses the drive enclosure 120 on a SAN block-by-block basis in response to a request from the SAN engine 222. For example, when a write request is sent from the host apparatus 302, the block driver 224 acquires, from the SAN engine 222, write data on a SAN block-by-block basis, which write data has been transmitted to the SAN engine 222 from the host apparatus 302, and then writes the data to the drive enclosure 120. When a read request is sent from the host apparatus 302, the block driver 224 reads, from the drive enclosure 120, requested data on a SAN block-by-block basis, and passes the data to the SAN engine 222. Then, the data is transmitted to the host apparatus 302.

On the other hand, when a write request is sent from the host apparatus 301, the block driver 224 acquires, from the block assigning unit 222a, write data on a SAN block-by-block basis and then writes the data to the drive enclosure 120. When a read request is sent from the host apparatus 301, the block driver 224 reads, from the drive enclosure 120, requested data on a SAN block-by-block basis, and passes the data to the block assigning unit 222a.

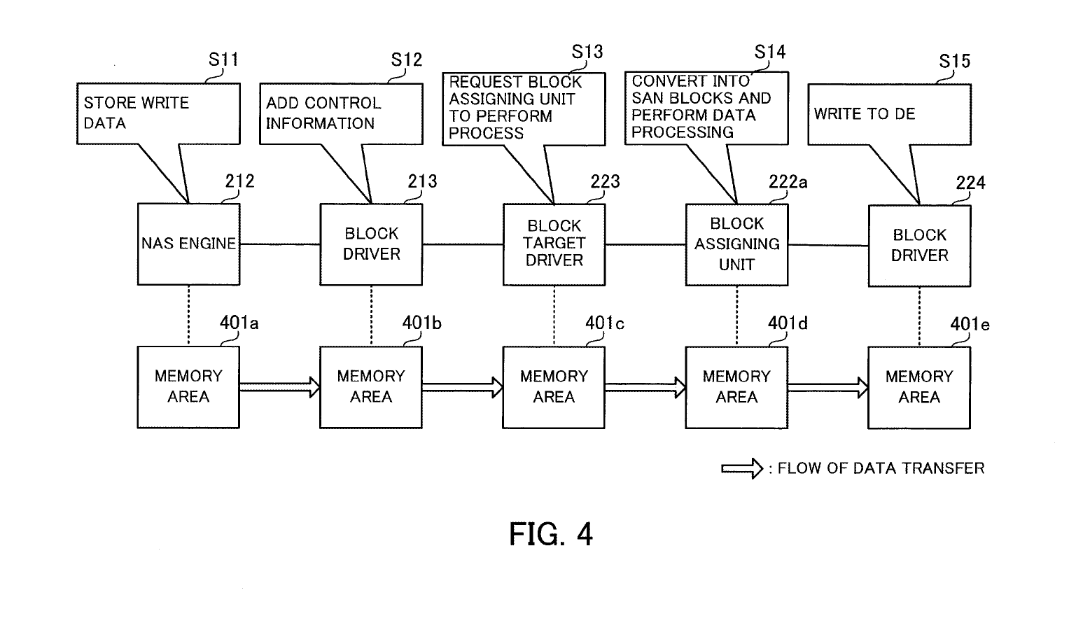

Next described are comparative examples of processes each performed when the host apparatus 301 requests the controller module 110 for file-based write access and when the host apparatus 301 requests the controller module 110 for file-based read access. First, FIG. 4 illustrates a comparative example of a process performed in response to a request for file-based write access. When a request for file-based write access is made, data requested to be written is sequentially passed through the NAS engine 212, the block driver 213, the block target driver 223, the block assigning unit 222a, and the block driver 224 in the stated order. The data is subjected to an as-needed process by each of the processing functions. Note in the following description that each of the NAS engine 212, the block driver 213, the block target driver 223, the block assigning unit 222a, and the block driver 224 may be referred to as the “application” in the case where no particular distinction needs to be made among them.

As illustrated in FIG. 4, the hypervisor 230 assigns, as work areas, memory areas 401a, 401b, 401c, 401d, and 401e to the NAS engine 212, the block driver 213, the block target driver 223, the block assigning unit 222a, and the block driver 224, respectively. Each of the memory areas 401a and 401b is assigned from the virtual memory space of the virtual machine 210. On the other hand, each of the memory areas 401c to 401e is assigned from the virtual memory space of the virtual machine 220.

Each of the above-described applications executes, for example, the following process. The NAS engine 212 stores, in the memory area 401a, write data received from the host apparatus 301 (step S11). The NAS engine 212 issues a write request command for the write data to the block driver 213, and also copies the data stored in the memory area 401a to the memory area 401b. In issuing the write request command to the block driver 213, a file system provided in the virtual operating system 211 calculates block addresses obtained when a file targeted by the write request command is divided into NAS blocks. Subsequently, the NAS engine 212 issues the write request command with NAS block-based addresses to the block driver 213.

Based on the write request command issued by the NAS engine 212, the block driver 213 adds NAS block-based control information to the write data copied to the memory area 401b (step S12). Herewith, the file targeted by the write request command is divided into NAS block-based data pieces. The block driver 213 requests the block target driver 223 of the virtual machine 220 for the next process, and also copies the write data with the control information added thereto from the memory area 401b to the memory area 401c. The block target driver 223 requests the block assigning unit 222a for the next process (step S13), and also copies the data stored in the memory area 401c to the memory area 401d.

The block assigning unit 222a converts the NAS block-based write data stored in the memory area 401d to SAN block-based write data, and further performs predetermined data processing on the converted write data (step S14). The conversion to the SAN block-based write data is achieved by adding, to the write data, SAN block-based control information in place of the control information added in step S12. Herewith, the NAS block-based write data is rearranged into SAN blocks. In addition, examples of the data processing include compression processing and data conversion processing according to a predetermined Redundant Arrays of Inexpensive Disks (RAID) level. When finishing all the processing, the block assigning unit 222a requests the block driver 224 for the next process, and also copies the processed write data stored in the memory area 401d to the memory area 401e. Based on the request from the block assigning unit 222a, the block driver 224 writes the SAN block-based write data stored in the memory area 401e to a corresponding HDD in the drive enclosure 120 (step S15).

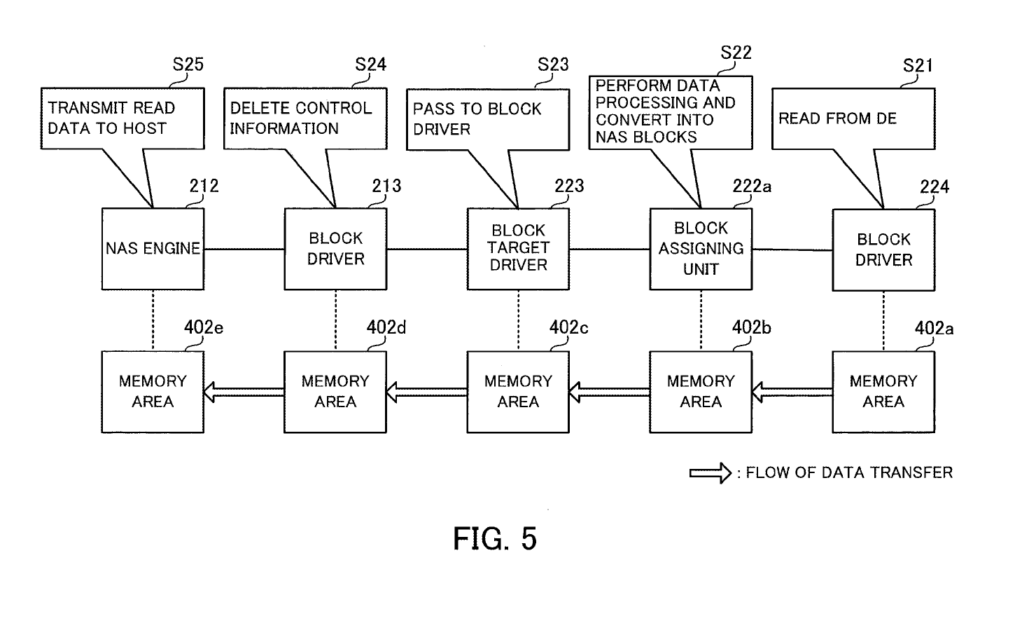

FIG. 5 illustrates a comparative example of a process performed in response to a request for file-based read access. When a request for file-based read access is made, data requested to be read is sequentially passed through the block driver 224, the block assigning unit 222a, the block target driver 223, the block driver 213, and the NAS engine 212. The data is subjected to an as-needed process by each of the applications.

As illustrated in FIG. 5, the hypervisor 230 assigns, as work areas, memory areas 402a, 402b, 402c, 402d, and 402e to the block driver 224, the block assigning unit 222a, the block target driver 223, the block driver 213, and the NAS engine 212, respectively. Each of the memory areas 402a to 402c is assigned from the virtual memory space of the virtual machine 220. On the other hand, each of the memory areas 402d and 402e is assigned from the virtual memory space of the virtual machine 210.

Each of the above-described applications executes, for example, the following process. The block driver 224 reads the data requested to be read from a corresponding HDD in the drive enclosure 120 on a SAN block-by-block basis, and stores the read data in the memory area 402a (step S21). The block driver 224 requests the block assigning unit 222a for the next process, and also copies, to the memory area 402b, the read data stored in the memory area 402a. SAN block-based control information is attached to the read data stored in the memory area 402a.

The block assigning unit 222a performs predetermined data processing on the read data stored in the memory area 402b, and further converts the SAN block-based read data after the data processing to NAS block-based read data (step S22). The data processing is an inverse conversion of the data processing in step S14 of FIG. 4. For example, when data compression is performed in step S14, data decompression is performed in step S22. The conversion to the NAS block-based read data is achieved by adding, to the read data, NAS block-based control information in place of the SAN block-based control information. Herewith, the SAN block-based read data read from the drive enclosure 120 is rearranged into NAS block-based read data. When finishing all the processing, the block assigning unit 222a requests the block target driver 223 for the next process, and also copies the NAS block-based data together with the control information from the memory area 402b to the memory area 402c.

The block target driver 223 requests the block driver 213 for the next process, and also copies the data stored in the memory area 402c to the memory area 402d. Herewith, the block target driver 223 passes the NAS block-based read data to the block driver 213 (step S23). The block driver 213 deletes the control information added to the read data, and converts the read data to data referable by the NAS engine 212 (step S24). The block driver 213 requests the NAS engine 212 for the next process, and also copies the read data with no control information attached thereto from the memory area 402d to the memory area 402e. In step S24, the file system informs the NAS engine 212 of file-based dividing positions of the read data stored in the memory area 402e. The NAS engine 212 reads the read data stored in the memory area 402e on a file-by-file basis, and transmits the read file to the host apparatus 301 (step S25).

According to the processing procedure of FIG. 4, even if a file-based write request is placed by the host apparatus 301, data requested to be written is stored in the drive enclosure 120 on a SAN block-by-block basis. In addition, according to the processing procedure of FIG. 5, even if a file-based read request is placed by the host apparatus 301, data requested to be read is read from the drive enclosure 120 on a SAN block-by-block basis and converted to file-based data, which is then transmitted to the host apparatus 301.

However, as illustrated in FIGS. 4 and 5, when a file-based write or read request is made, write or read data is passed through a plurality of applications while undergoing an as-needed conversion and process. In addition, the write or read data is copied each time the data is passed from one application to another. Amongst the processes performed by the individual applications on data in their corresponding memory areas, illustrated in FIGS. 4 and 5, the data conversion and process by the block assigning unit 222a impose the highest processing load. Then, amongst the remaining processes, the replacement of one-type block-based control information to the other-type block-based control information imposes the highest processing load, which does not involve an input or output of all write or read data stored in the corresponding memory area. Therefore, the processing load imposed by each application when processing data in its corresponding memory area is overwhelmingly lower than the load of copying data between applications from the entire application perspective.

Hence, the load of data copy between applications accounts for a relatively large proportion compared to the entire processing load of the write or read access. Especially, large volumes of data are increasingly handled in recent years, and in association with this, the processing load associated with the above-described data copy processes has become a large influence on the entire processing time.

For example, assume that the maximum transfer speed between the controller module 110 and the drive enclosure 120 is χ (MB/s); the rate of decrease in the transfer speed due to a corresponding application performing its processing, such as conversion and data processing, on data in the corresponding memory area illustrated in FIG. 4 is α (%); and the rate of decrease in the transfer speed due to data copying between memory areas is β (%). Assume also that the processing, such as conversion and data processing, by applications takes place three times and data coping between memory areas takes place four times. In this case, the overall transfer speed is calculated, for example, using the following formula: (1−α) (1−β)⁴χ. When χ is 300 MB/s, α is 5%, and β is 3%, the overall transfer speed is 227.7 MB/s, a 24% decrease in the transfer speed performance. In addition, as for the processing load on the processor of the controller module 110, most of the processing time of the processor is given to the data transfer with the drive enclosure 120 and the data copying between the memory areas. As a result, not only the response speed of the controller module 110 to the host apparatuses 301 and 302 but also the speed of the controller module 110 to execute other processes drops significantly.

In view of the above-described problems, according to the second embodiment, the controller module 110 changes assignment of physical memory areas to individual memory areas to which applications refer when data is passed through the applications. This eliminates the need of substantial data transfer to pass the data through the applications. Such control is implemented by the memory control unit 231 of the hypervisor 230.

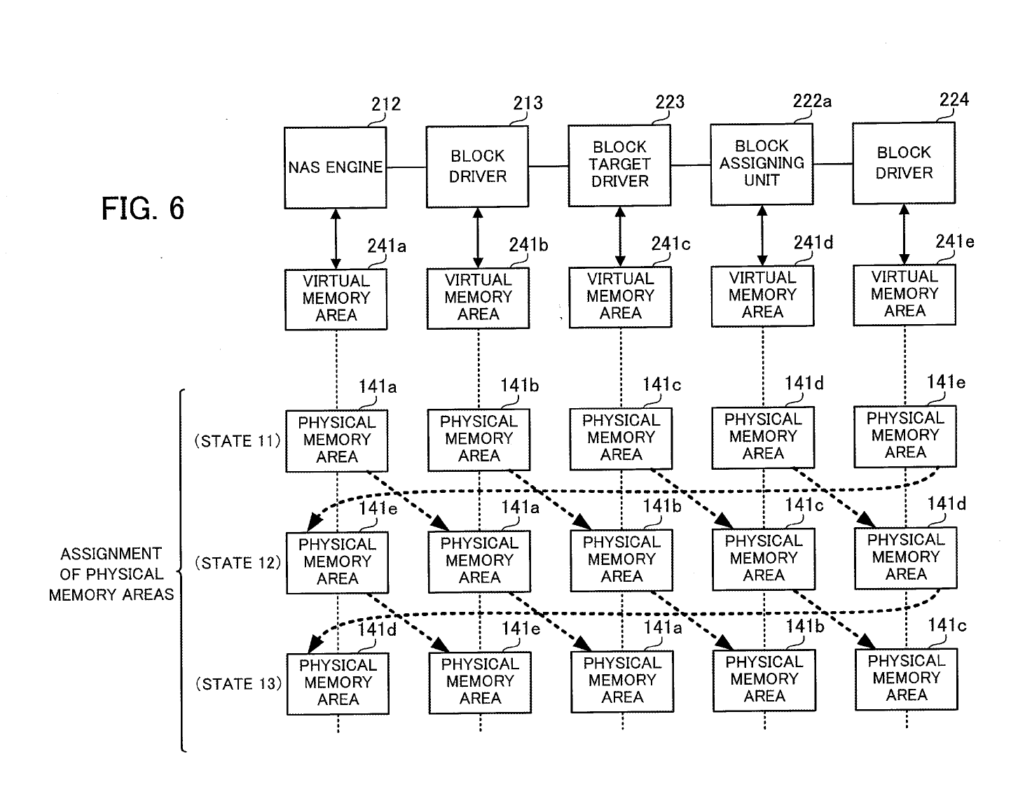

FIG. 6 illustrates an operation example of data passing through applications, performed in response to a request for file-based write access. In executing write access in response to a file-based write request from the host apparatus 301, the memory control unit 231 assigns, as work areas, virtual memory areas 241a, 241b, 241c, 241d, and 241e to the NAS engine 212, the block driver 213, the block target driver 223, the block assigning unit 222a, and the block driver 224, respectively. Each of the virtual memory areas 241a and 241b is assigned from the virtual memory space of the virtual machine 210. On the other hand, each of the virtual memory areas 241c to 241e is assigned from the virtual memory space of the virtual machine 220. Note that the virtual memory areas 241a to 241e have the same capacity. In addition, from this point until the end of the write access, no change is made to the assignment of the virtual memory areas to the individual applications as their work areas.

In addition, the memory control unit 231 secures five physical memory areas 141a to 141e in the RAM 112 of the controller module 110. The capacity of each of the physical memory areas 141a to 141e is the same as that of the individual virtual memory areas 241a to 241e. The memory control unit 231 assigns one of the physical memory areas 141a to 141e to each of the virtual memory areas 241a to 241e. In assigning the physical memory areas 141a to 141e, the memory control unit 231 circularly changes the physical memory areas to be assigned to the virtual memory areas in the data transfer direction.

For example, in State 11 of FIG. 6, the memory control unit 231 assigns the physical memory areas 141a, 141b, 141c, 141d, and 141e to the virtual memory areas 241a, 241b, 241c, 241d, and 241e, respectively. In this state, the NAS engine 212 performs a process like step S11 of FIG. 4 while using the physical memory area 141a. The block driver 213 performs a process like step S12 of FIG. 4 while using the physical memory area 141b. The block target driver 223 performs a process like step S13 of FIG. 4 while using the physical memory area 141c. The block assigning unit 222a performs a process like step S14 of FIG. 4 while using the physical memory area 141d. The block driver 224 performs a process like step S15 of FIG. 4 while using the physical memory area 141e. Note however that each of these processes by the individual applications, corresponding to steps S11 to S15 of FIG. 4, does not include data copying to a virtual memory area corresponding to the next application. Note that the processes by the individual applications are performed in parallel.

When the processes of the individual applications are completed, the memory control unit 231 reassigns the physical memory areas 141a to 141e to the virtual memory areas 241a to 241e. In this regard, the memory control unit 231 reassigns each physical memory area currently assigned to a virtual memory area corresponding to an application to a virtual memory area corresponding to the next application following the application. For example, as illustrated in State 12 of FIG. 6, the physical memory area 141a is reassigned from the virtual memory area 241a to the virtual memory area 241b. The physical memory area 141b is reassigned from the virtual memory area 241b to the virtual memory area 241c. The physical memory area 141c is reassigned from the virtual memory area 241c to the virtual memory area 241d. The physical memory area 141d is reassigned from the virtual memory area 241d to the virtual memory area 241e. The physical memory area 141e is reassigned from the virtual memory area 241e to the virtual memory area 241a. In this condition, the individual applications perform their processes in parallel.

Further, when the processes of the individual applications in State 12 are completed, the memory control unit 231 reassigns the physical memory areas 141a to 141e to the virtual memory areas 241a to 241e. Herewith, the assignment of the physical memory areas 141a to 141e in State 12 is shifted to that in State 13. In State 13, the physical memory area 141a is reassigned from the virtual memory area 241b to the virtual memory area 241c. The physical memory area 141b is reassigned from the virtual memory area 241c to the virtual memory area 241d. The physical memory area 141c is reassigned from the virtual memory area 241d to the virtual memory area 241e. The physical memory area 141d is reassigned from the virtual memory area 241e to the virtual memory area 241a. The physical memory area 141e is reassigned from the virtual memory area 241a to the virtual memory area 241b.

As described above, the physical memory areas are circularly reassigned to the individual virtual memory areas in the data transfer direction. This allows data in a virtual memory area currently referred to by an application to become referable by the next application without transfer of the data across the physical memory space. For example, the physical memory area 141a assigned to the virtual memory area 241a referred to by the NAS engine 212 in State 11 is reassigned to the virtual memory area 241b referred to by the block driver 213 in State 12. This allows data stored in the virtual memory area 241a in State 11 to be referred to by the block driver 213 in State 12. Herewith, it is possible to pass the data through the applications without transfer of the data across the physical memory space, resulting in a decrease in the processing load on the processor 111. Note that, as described later, the data passing through the applications simply involves rewriting an address conversion table, which incurs a considerably lower processing load compared to physically transferring the data across the physical memory space.

Note that different write data is stored in each of the virtual memory areas 241a to 241e. Then, the applications perform individual processes in parallel on the data stored in their corresponding virtual memory areas. As described above, when the processes of the individual applications using the corresponding virtual memory areas are completed, the physical memory areas are circularly reassigned to the virtual memory areas in the data transfer direction. Herewith, the processing load accompanying the data passing among the individual applications is reduced while maintaining processing parallelism among the applications.

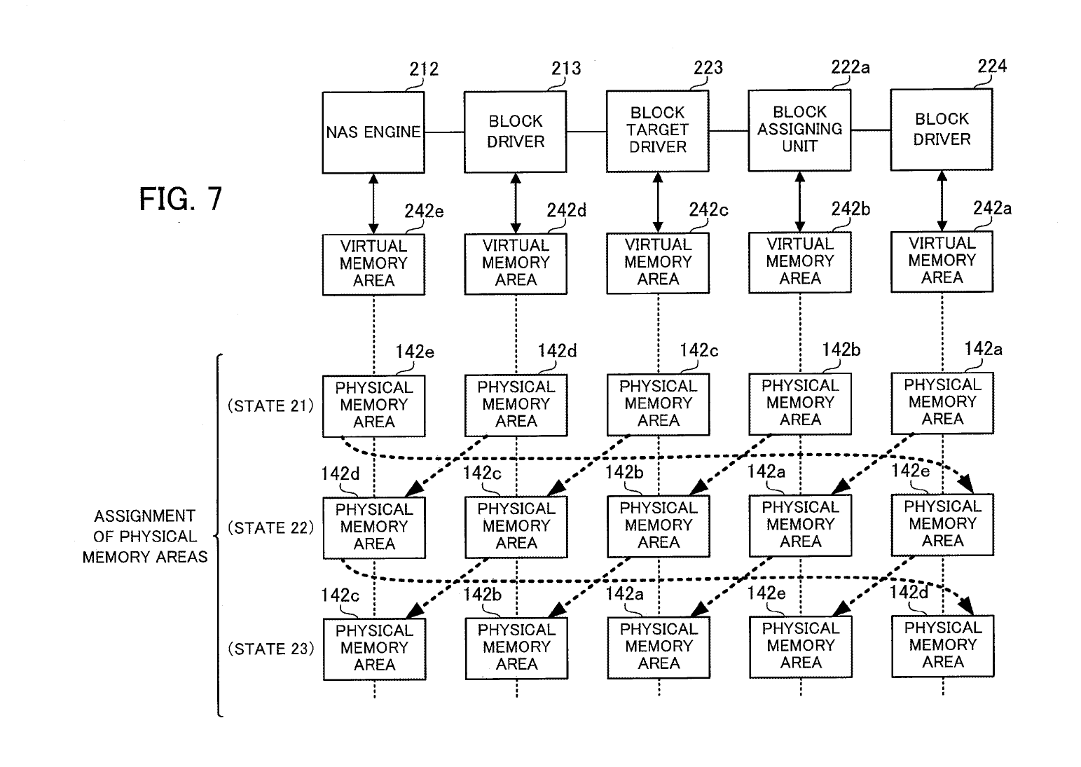

FIG. 7 illustrates an operation example of data passing through the applications, performed in response to a request for file-based read access. In executing read access in response to a file-based read request from the host apparatus 301, the memory control unit 231 assigns, as work areas, virtual memory areas 242a, 242b, 242c, 242d, and 242e to the block driver 224, the block assigning unit 222a, the block target driver 223, the block driver 213, and the NAS engine 212, respectively. Each of the virtual memory areas 242a to 242c is assigned from the virtual memory space of the virtual machine 220. On the other hand, each of the memory areas 242d and 242e is assigned from the virtual memory space of the virtual machine 210. Note that, as in the case of a write request, the virtual memory areas 242a to 242e have the same capacity. In addition, from this point until the end of the read access, no change is made to the assignment of the virtual memory areas to the individual applications as their work areas.

In addition, the memory control unit 231 secures five physical memory areas 142a to 142e in the RAM 112 of the controller module 110. The capacity of each of the physical memory areas 142a to 142e is the same as that of the individual virtual memory areas 242a to 242e. The memory control unit 231 assigns one of the physical memory areas 142a to 142e to each of the virtual memory areas 242a to 242e. In assigning the physical memory areas 142a to 142e, the memory control unit 231 circularly changes the physical memory areas to be assigned to the virtual memory areas in the data transfer direction.

For example, in State 21 of FIG. 7, the memory control unit 231 assigns the physical memory areas 142a, 142b, 142c, 142d, and 142e to the virtual memory areas 242a, 242b, 242c, 242d, and 242e, respectively. In this state, the block driver 224 performs a process like step S21 of FIG. 5 while using the physical memory area 142a. The block assigning unit 222a performs a process like step S22 of FIG. 5 while using the physical memory area 142b. The block target driver 223 performs a process like step S23 of FIG. 5 while using the physical memory area 142c. The block driver 213 performs a process like step S24 of FIG. 5 while using the physical memory area 142d. The NAS engine 212 performs a process like step S25 of FIG. 5 while using the physical memory area 142e. Note however that each of these processes by the individual applications, corresponding to steps S21 to S25 of FIG. 5, does not include data copying to a virtual memory area corresponding to the next application.

When the processes of the individual applications are completed, the memory control unit 231 reassigns the physical memory areas 142a to 142e to the virtual memory areas 242a to 242e. In this regard, the memory control unit 231 reassigns each physical memory area currently assigned to a virtual memory area corresponding to an application to a virtual memory area corresponding to the next application following the application. For example, as illustrated in State 22 of FIG. 7, the physical memory area 142a is reassigned from the virtual memory area 242a to the virtual memory area 242b. The physical memory area 142b is reassigned from the virtual memory area 242b to the virtual memory area 242c. The physical memory area 142c is reassigned from the virtual memory area 242c to the virtual memory area 242d. The physical memory area 142d is reassigned from the virtual memory area 242d to the virtual memory area 242e. The physical memory area 142e is reassigned from the virtual memory area 242e to the virtual memory area 242a.

Further, when the processes of the individual applications in State 22 are completed, the memory control unit 231 reassigns the physical memory areas 142a to 142e to the virtual memory areas 242a to 242e. Herewith, the assignment of the physical memory areas 142a to 142e in State 22 is shifted to that in State 23. In State 23, the physical memory area 142a is reassigned from the virtual memory area 242b to the virtual memory area 242c. The physical memory area 142b is reassigned from the virtual memory area 242c to the virtual memory area 242d. The physical memory area 142c is reassigned from the virtual memory area 242d to the virtual memory area 242e. The physical memory area 142d is reassigned from the virtual memory area 242e to the virtual memory area 242a. The physical memory area 142e is reassigned from the virtual memory area 242a to the virtual memory area 242b.

Thus, in the read access, the physical memory areas are circularly reassigned to the individual virtual memory areas in the data transfer direction, as in the case of the write access described above. This allows data in a virtual memory area currently referred to by an application to become referable by the next application without transfer of the data across the physical memory space. Herewith, it is possible to pass the data through the applications without transfer of the data across the physical memory space, resulting in a decrease in the processing load on the processor 111.

Note that different read data is stored in each of the virtual memory areas 242a to 242e, as in the case of the above-described write access. Then, the applications perform individual processes in parallel on the data stored in their corresponding virtual memory areas. As described above, when the processes of the individual applications using the corresponding virtual memory areas are completed, the physical memory areas are circularly reassigned to the virtual memory areas in the data transfer direction. Herewith, the processing load accompanying the data passing among the individual applications is reduced while maintaining processing parallelism among the applications.

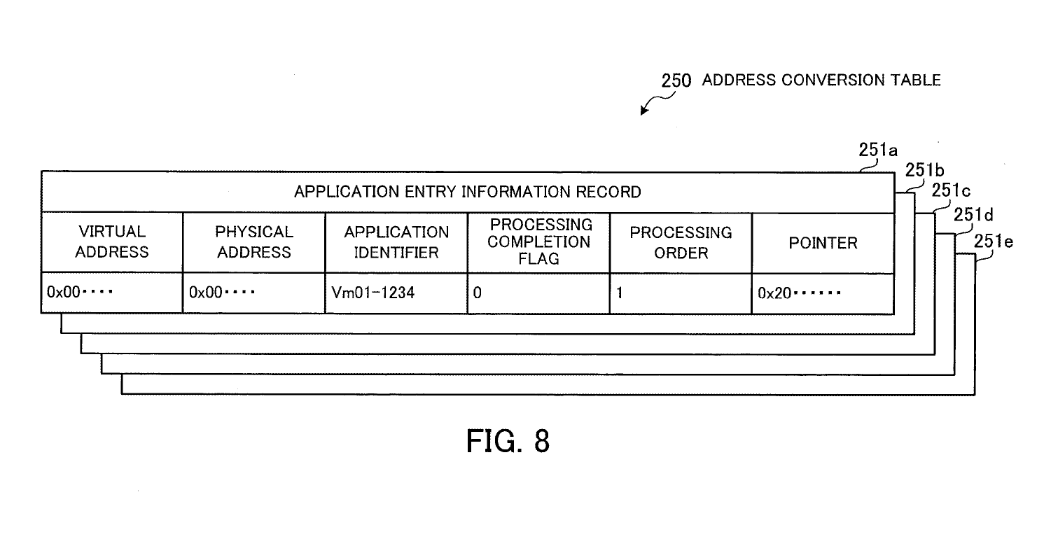

FIG. 8 illustrates an example of a data structure of an address conversion table. An address conversion table 250 primarily registers therein mappings between the virtual memory areas referred to by the individual applications and the physical memory areas. The address conversion table 250 maps physical memory addresses to an address space referable by each of the virtual operating systems 211 and 221. The memory control unit 231 generates the address conversion table 250 and then records it in the RAM 112, and also implements updates to the address conversion table 250.

In executing write or read access in response to a request from the host apparatus 301, entry information records 251a to 251e are registered in the address conversion table 250. Each of the entry information records 251a to 251e is associated with one of the applications through which data is passed in the above-described manner, that is, one of the NAS engine 212, the block driver 213, the block target driver 223, the block assigning unit 222a, and the block driver 224.

Each of the entry information records 251a to 251e includes the following items: virtual address; physical address; application identifier; processing completion flag; processing order; and pointer. The field of the virtual address contains the first memory address of the virtual memory area referred to by its associated application. The address registered in the field is an address in the virtual memory space referred to by the virtual operating system including the associated application. The field of the physical address contains the first memory address of the physical memory area assigned to the corresponding virtual memory area. During the execution of write or read access, the address value registered in the field of the physical address is changed. Herewith, a physical memory area to be assigned to the corresponding virtual memory area is changed.

The field of the application identifier contains identification information to identify the corresponding application, that is, one of the NAS engine 212, the block driver 213, the block target driver 223, the block assigning unit 222a, and the block driver 224. The field of the processing completion flag contains flag information indicating whether the execution of the process by the associated application using the corresponding virtual memory area has been completed. A value “0” is set in the field when the execution of the process has yet to be completed, and a value “1” is set in the field when the execution of the process is completed.

The field of the processing order contains the number indicating the order of data passing. For example, in the case of write access, numbers are sequentially assigned in the order of: the NAS engine 212; the block driver 213; the block target driver 223; the block assigning unit 222a; and the block driver 224. In the case of read access, the numbers are assigned in the reverse order. Note that the order of data passing does not necessarily need to be registered in the address conversion table 250, and it may be written, for example, in a program code for implementing processes of the memory control unit 231.

The field of the pointer contains information indicating the location of the next entry information record. In the address conversion table 250, the entry information records 251a to 251e are linked in a chain by the location information registered in their individual fields of the pointer. Note however that the entry information records 251a to 251e being linked in a chain is merely an example of the structure of the address conversion table 250, and the address conversion table 250 may have a different structure. In practice, the address conversion table 250 described above is separately generated for each of write access and read access, and then recorded in the RAM 112.

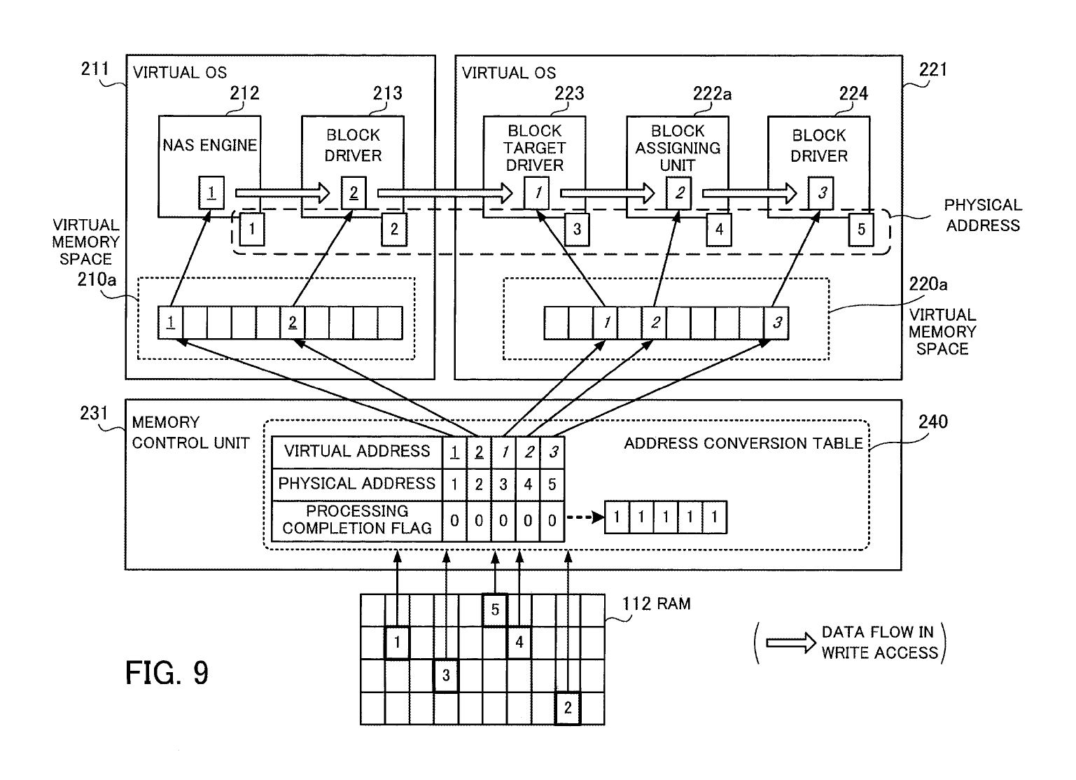

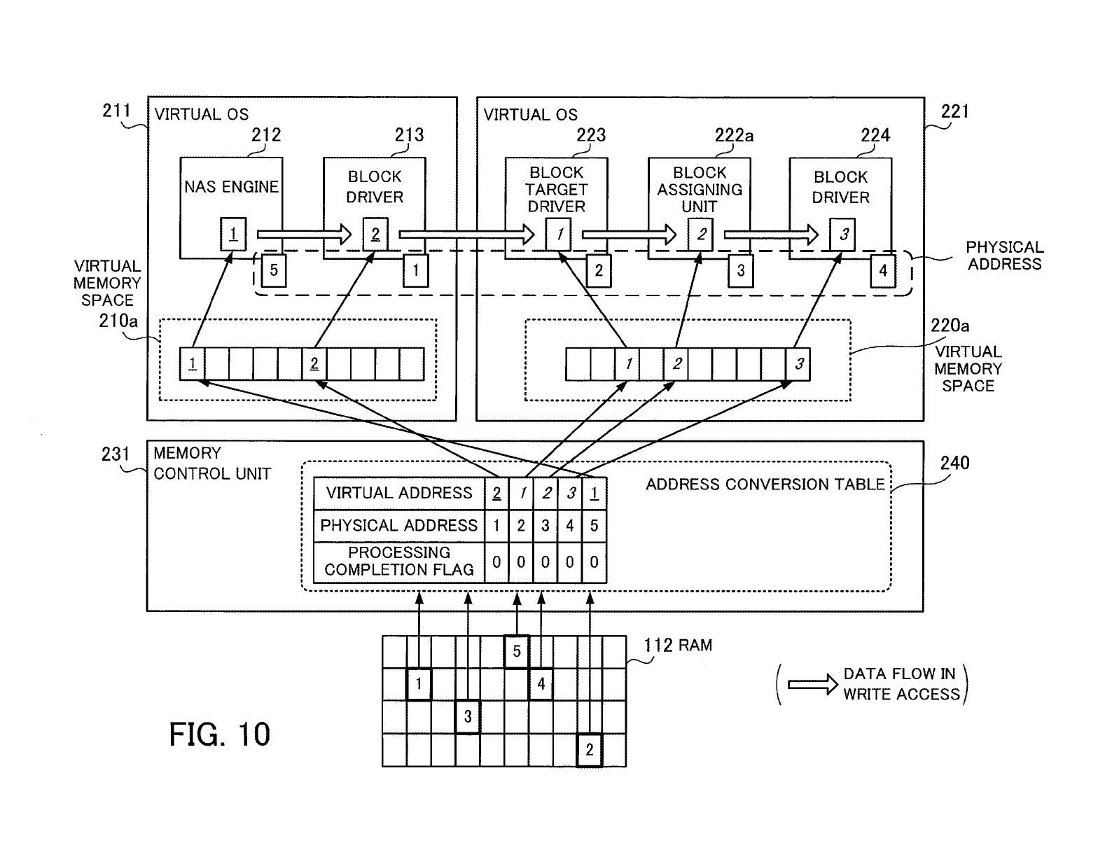

FIGS. 9 and 10 illustrate an example of updating the address conversion table during write access. Note that, as for the address conversion table 250 in FIGS. 9 and 10, not all the information items but only mappings among virtual addresses of the virtual memory areas, physical addresses of the physical memory areas, and the processing completion flags are illustrated. In addition, in FIGS. 9 and 10, each underlined numerical value of a virtual address indicates an address value in a virtual memory space 210a referred to by the virtual operating system 211. On the other hand, each italic numerical value of a virtual address indicates an address value in a virtual memory space 220a referred to by the virtual operating system 221.

According to the example of FIGS. 9 and 10, the NAS engine 212 and the block driver 213 refer to addresses “1” and “2”, respectively, in the virtual memory space 210a. On the other hand, the block target driver 223, the block assigning unit 222a, and the block driver 224 refer to addresses “1”, “2”, and “3”, respectively, in the virtual memory space 220a. In FIG. 9, the virtual memory areas individually corresponding to the NAS engine 212 and the block driver 213 are assigned physical addresses “1” and “2”, respectively, of the RAM 112. The virtual memory areas individually corresponding to the block target driver 223, the block assigning unit 222a, and the block driver 224 are assigned physical addresses “3”, “4”, and “5”, respectively, of the RAM 112.

At the time the memory control unit 231 of the hypervisor 230 has assigned the physical memory areas in the above-described manner, the processing completion flags of all the applications are set to “0”. From this point, each of the applications executes its corresponding process. When having completed the execution of its process using the corresponding virtual memory area, each application notifies the memory control unit 231 of the process completion. Upon receiving such a completion notice from an application, the memory control unit 231 updates the processing completion flag of the application to “1”. When the processing completion flags of all the applications have been updated to “1” in this manner, the memory control unit 231 reassigns the physical memory areas to the individual virtual memory areas.

In FIG. 10, the assignment destination of the physical memory area identified by the physical address “1” has been changed from the virtual memory area referred to by the NAS engine 212 to the virtual memory area referred to by the block driver 213. This allows data processed by the NAS engine 212 in FIG. 9 to be passed to the block driver 213, involving no physical transfer of the data. Similarly, in FIG. 10, the assignment destination of the physical memory area identified by the physical address “2” has been changed from the virtual memory area referred to by the block driver 213 to the virtual memory area referred to by the block target driver 223. The assignment destination of the physical memory area identified by the physical address “3” has been changed from the virtual memory area referred to by the block target driver 223 to the virtual memory area referred to by the block assigning unit 222a. Further, the assignment destination of the physical memory area identified by the physical address “4” has been changed from the virtual memory area referred to by the block assigning unit 222a to the virtual memory area referred to by the block driver 224. Herewith, involving no physical data transfer, data processed by the block driver 213 in FIG. 9 is passed to the block target driver 223; data processed by the block target driver 223 in FIG. 9 is passed to the block assigning unit 222a; and data processed by the block assigning unit 222a in FIG. 9 is passed to the block driver 224.

Note that data stored in the physical memory area identified by the physical address “5” in FIG. 9 is not needed after the completion of the process by the block driver 224. For this reason, when the assignment state is shifted to the one illustrated in FIG. 10, the memory control unit 231 changes the assignment destination of the physical address “5” to the virtual memory area referred to by the NAS engine 212. Herewith, the physical memory area identified by the physical address “5” is overwritten with new write data having undergone the process of the NAS engine 212.

As illustrated in FIG. 9 above, after assigning the physical memory areas to the individual virtual memory areas, the memory control unit 231 waits for a processing completion notice sent from each application associated with one of the virtual memory areas. Then, upon receiving a processing completion notice from an application, the memory control unit 231 updates the processing completion flag corresponding to the application to “1”. When the processing completion flags of all the applications are updated to “1”, the memory control unit 231 determines that data passing among the applications becomes possible and reassigns the physical memory areas to the individual virtual memory areas.

In the above-described manner, the memory control unit 231 is able to recognize whether the process of each application has been completed, which allows simultaneous reassignment of the physical memory areas to the individual virtual memory areas in a circular manner. Herewith, the processing load accompanying the data passing among the individual applications is reduced while maintaining processing parallelism among the applications.

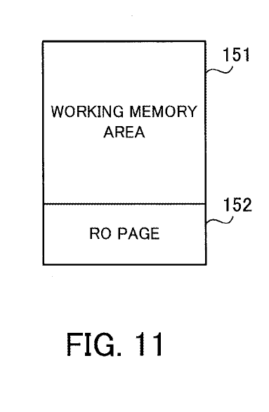

FIG. 11 illustrates an example of a mechanism for each application to notify the memory control unit of processing completion. A working memory area 151 is secured in the RAM 112 by the memory control unit 231 as a shared memory area commonly referable by a plurality of processes on a plurality of virtual machines. Dynamic address conversion by the memory control unit 231 enables reassignment of a virtual memory address associated with the working memory area 151. This allows a single working memory area 151 to be referable and updated by the plurality of processes.

A read-only page 152 is a page (a memory area in the RAM 112) with a read-only attribute. Each read-only page 152 is secured in combination with one working memory area 151. When a process referring to a working memory area 151 tries to write data in a read-only page 152 corresponding to the working memory area 151, an interrupt occurs which notifies the memory control unit 231 of a write request. This interrupt is used as a trigger to notify the memory control unit 231 of the process using the working memory area 151 having been completed. When detecting the occurrence of the interrupt, the memory control unit 231 reassigns a virtual memory address associated with the working memory area 151. This allows exclusive access from each of the plurality of processes to the working memory area 151 shared by the processes.

In the case where write or read access is made in response to a request from the host apparatus 301, the memory control unit 231 secures as many pairs of the working memory area 151 and the read-only page 152 as the number of applications to be allowed to refer to the working memory areas 151. All the working memory areas 151 have the same capacity. The memory control unit 231 sequentially assigns virtual memory areas each associated with one of the applications to the individual working memory areas 151 according to the order of data passing among the applications. Herewith, the data passing among the applications illustrated in FIGS. 6 and 7 is implemented.

When having completed the process using the assigned working memory area 151, each application writes data in the read-only page 152 corresponding to the working memory area 151 and transitions to a sleep state. When having detected the occurrence of interrupts associated with data writes by all the applications, the memory control unit 231 determines that the processes of all the applications have been completed, and then reassigns the virtual addresses associated with the individual working memory areas 151. After the reassignment of the virtual addresses, the memory control unit 231 sends a wake-up signal to each of the applications to cause the application to start its processing using a newly assigned working memory area 151.

The above-described mechanism allows simultaneous reassignment of the physical memory areas to the individual virtual memory areas in a circular manner. Herewith, the processing load accompanying the data passing among the individual applications is reduced while maintaining processing parallelism among the applications.

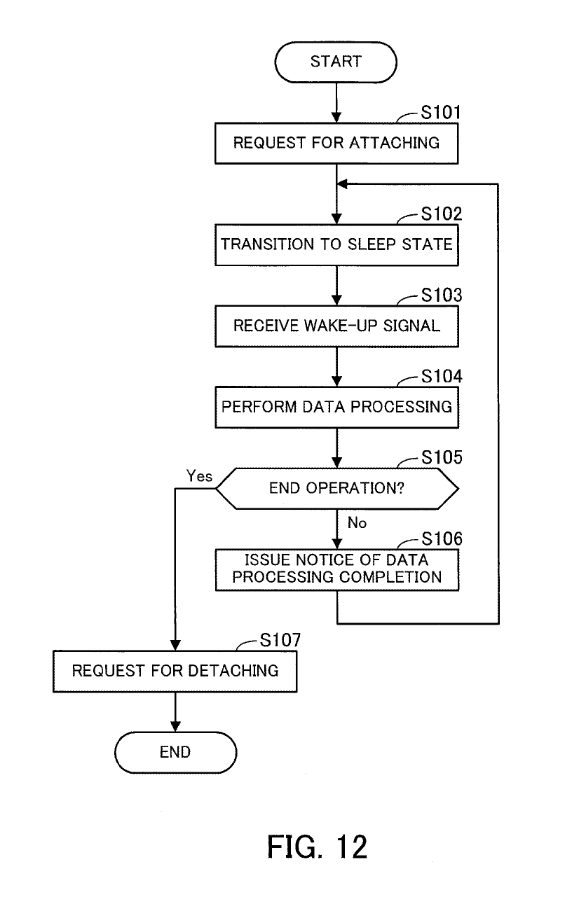

With reference to flowcharts, next described is processing of the controller module 110 in response to a write or read request with a file designated, which request is issued from the host apparatus 301. FIG. 12 is a flowchart illustrating an example of a processing procedure of an application. The procedure of FIG. 12 is executed by each application, that is, each of the NAS engine 212, the block driver 213, the block target driver 223, the block assigning unit 222a, and the block driver 224, at the time of starting an operation accompanied by a write or read request from the host apparatus 301. Note that the procedure of FIG. 12 is separately executed for each of write access and read access.

[Step S101] The application requests the memory control unit 231 for attaching. Attaching refers to making a shared memory area composed of a plurality of working memory areas 151 available to the application.

[Step S102] The application transitions to a sleep state where the execution of its process is suspended.

[Step S103] Upon receiving a wake-up signal from the memory control unit 231, the application performs step S104 and the subsequent steps.

[Step S104] The application executes data processing using its corresponding virtual memory area. In the case of write access, the data processing is, amongst steps S11 to S15 of FIG. 4, a process corresponding to the application. Note however that the process of the application does not include data copying to a virtual memory area corresponding to the next application. In the case of read access, the data processing is, amongst steps S21 to S25 of FIG. 5, a process corresponding to the application. Similarly, the process of the application does not include data copying to a virtual memory area corresponding to the next application.

[Step S105] When having completed the data processing in step S104, the application determines whether to end the operation accompanied by the write or read request from the host apparatus 301. When the operation is ended, the procedure moves to step S107. If the operation is not ended, the procedure moves to step S106.

[Step S106] The application notifies the memory control unit 231 of the completion of the data processing. The notice is implemented by an interrupt occurring in response to a write by the application to a read-only page secured together with a working memory area assigned to the corresponding virtual memory area, as described above.

[Step S107] The application requests the memory control unit 231 for detaching. Detaching refers to making the shared memory area not available to the application.

In the processing procedure of FIG. 12, each time the procedure moves to step S104, the application accesses a virtual memory area with the same virtual address, assigned to itself. However, in reality, a physical memory area which the application accesses is changed each time step S104 is performed. The application performs its data processing with no regard to the change of the access-destination physical memory area.

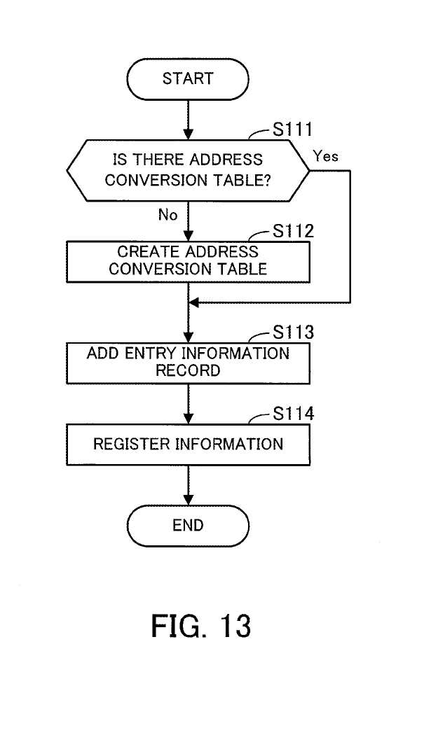

FIG. 13 illustrates an example of a processing procedure of the memory control unit upon receiving an attaching request. The processing procedure of FIG. 13 is performed each time an application requests the memory control unit 231 for attaching in step S101 of FIG. 12. For write access, the processing procedure of FIG. 13 is performed five times. Separately, for read access, the processing procedure of FIG. 13 is performed five times.

[Step S111] Upon receiving an attaching request from an application, the memory control unit 231 determines whether the address conversion table 250 has already been created. Note that, in the case of write access, the memory control unit 231 determines whether the address conversion table 250 for write access has been created. In the case of read access, the memory control unit 231 determines whether the address conversion table 250 for read access has been created. In the case where the address conversion table 250 has yet to be created, the procedure moves to step S112. If the address conversion table 250 has been created, the procedure moves to step S113.

[Step S112] The memory control unit 231 creates the address conversion table 250. The created address conversion table 250 is stored, for example, in the RAM 112. Note that, in step S112, in the case of write access, the address conversion table 250 dedicated to write access is created. On the other hand, in the case of read access, the address conversion table 250 dedicated to read access is created.

[Step S113] The memory control unit 231 adds an entry information record corresponding to the attaching-requestor application to the address conversion table 250.

[Step S114] The memory control unit 231 registers the following information to the entry information record added in step S113. In the field of the virtual address, the memory control unit 231 registers a virtual address corresponding to the attaching-requestor application. A working memory area 151 not assigned to a different virtual memory area is selected from the working memory areas 151 secured in the RAM 112. In the field of the physical address, the memory control unit 231 registers the beginning address of the selected working memory area 151. In the field of the application identifier, the memory control unit 231 registers the identification information for identifying the attaching-requestor application. In the field of the processing completion flag, the memory control unit 231 registers an initial value of 0. In the field of the processing order, the memory control unit 231 registers a number corresponding to the attaching-requestor application. In the field of the pointer, the memory control unit 231 registers information used to link the entry information record to a different entry information record included in the address conversion table 250.

In each of the fields of the virtual address and the processing order, information predetermined for the attaching-requestor application is registered. Note however that the information registered in each of the fields is different between write access and read access. In addition, each of write access and read access has a different group of entry information records linked by the information registered in the fields of the pointer.

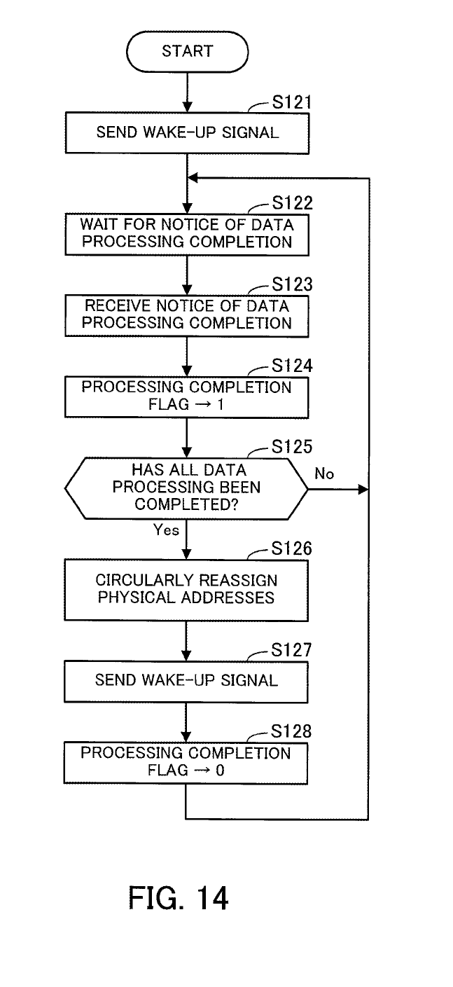

The processing procedure of FIG. 14 is carried out when entry information records corresponding to all the applications are registered in the address conversion table 250 for each of write access and read access by the above-described procedure. FIG. 14 illustrates an example of a processing procedure of the memory control unit, associated with the execution of data processing by the applications. Note that the processing procedure of FIG. 14 is separately executed for each of write access and read access. In addition, a different address conversion table 250 is referred to in each of write access and read access.

[Step S121] The memory control unit 231 sends a wake-up signal to all the applications. Herewith, each of the applications starts the execution of its data processing in step S104 of FIG. 12.

[Step S122] The memory control unit 231 waits for a notice of data processing completion to be sent from each application.

[Step S123] Upon receiving a notice of data processing completion from one application, the memory control unit 231 moves to step S124.

[Step S124] The memory control unit 231 selects, amongst entry information records in the address conversion table 250, an entry information record corresponding to the application having sent the notice of data processing completion. The memory control unit 231 updates the value in the field of the processing completion flag in the selected entry information record from “0” to “1”.

[Step S125] The memory control unit 231 determines whether all the applications have completed their data processing. The memory control unit 231 determines that all the applications have completed their data processing when the value “1” is set in the field of the processing completion flag in each of all the entry information records of the address conversion table 250. When determining that all the applications have completed their data processing, the memory control unit 231 moves to step S126. If one or more applications have not completed their data processing, the memory control unit 231 returns to step S122.

[Step S126] The memory control unit 231 circularly reassigns the physical addresses registered in the entry information records corresponding to all the applications in a manner illustrated in FIG. 6 or FIG. 7. In the reassignment, each of the physical addresses is shifted by one in the direction according to the processing order indicated in the entry information records.

[Step S127] The memory control unit 231 sends a wake-up signal to all the applications. Herewith, each of the applications starts the execution of its data processing in step S104 of FIG. 12.

[Step S128] As for each of the entry information records of all the applications in the address conversion table 250, the memory control unit 231 updates the value in the field of the processing completion flag from “1” to “0”.

Note that the processing order of steps S127 and S128 may be reversed. After steps S127 and S128, the procedure moves to step S122.

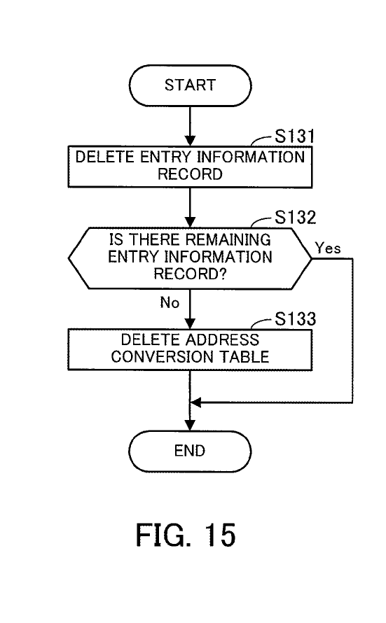

FIG. 15 illustrates an example of a processing procedure of the memory control unit upon receiving a detaching request. The procedure of FIG. 15 is executed when one of the applications requests the memory control unit 231 for detaching during the processing of FIG. 14. Note that the procedure of FIG. 15 is separately executed for each of write access and read access. For write access, the processing procedure of FIG. 15 is performed five times. Separately, for read access, the processing procedure of FIG. 15 is performed five times.

[Step S131] Upon receiving a detaching request from an application, the memory control unit 231 deletes an entry information record corresponding to the requestor application from the address conversion table 250.

[Step S132] The memory control unit 231 determines whether one or more entry information records remain in the address conversion table 250. If one or more entry information records remain, the process ends and the memory control unit 231 enters a wait state, waiting for a detaching request from a different application. If no entry information record remains, the memory control unit 231 moves to step S133.

[Step S133] The memory control unit 231 deletes the address conversion table 250.

The second embodiment described above does not involve substantial data transfer when data processed by each application is passed to the next application. Herewith, it is possible to reduce the processing load on the processor 111, which results in improving the response performance to access requests from the host apparatuses 301 and 302. In addition, in response to the completion of data processing of all the applications, the physical memory areas currently assigned to the virtual memory areas corresponding to the individual applications are reassigned all at once. This allows a reduction in the processing load accompanying data passing among the applications while maintaining processing parallelism among the applications.

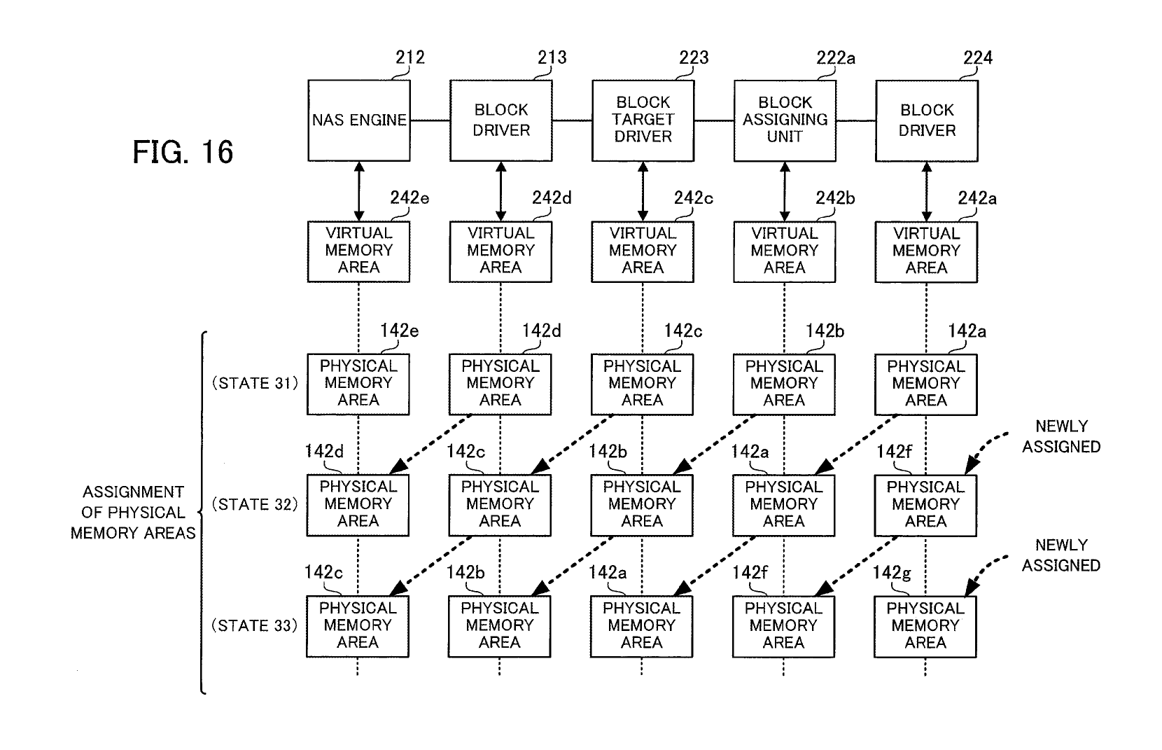

Note that, according to the second embodiment above, the memory control unit 231 secures in advance the fixed physical memory areas assignable to the virtual memory areas corresponding to the individual applications. Then, the memory control unit 231 circularly reassigns the physical memory areas to the virtual memory areas. On the other hand, as described next in FIG. 16, not the physical memory area currently assigned to a virtual memory area corresponding to the last application but a new physical memory area may be assigned to a virtual memory area corresponding to the first application. Next described is a modification in which the second embodiment is changed in such a manner.

FIG. 16 illustrates an operation example of changing assignment of physical memory areas according to a modification. FIG. 16 illustrates a case of read access. At the start of the read access, the memory control unit 231 secures the physical memory areas 142a to 142e as physical memory areas assignable to the virtual memory areas 242a to 242e, as in the case of FIG. 7. Then, in State 31 of FIG. 16, the memory control unit 231 assigns the physical memory areas 142a, 142b, 142c, 142d, and 142e to the virtual memory areas 242a, 242b, 242c, 242d, and 242e, respectively. In State 31, the assignment of the physical memory areas is the same as that in State 21 of FIG. 7.

When all the applications have completed their data processing in State 31, the memory control unit 231 changes the assignment of the physical memory areas to the virtual memory areas 242a to 242e. In this regard, as for the physical memory areas 142a to 142d, the memory control unit 231 shifts the individual assignment destinations by one virtual memory area in the data passing direction, as in the case of FIG. 7. That is, as illustrated in State 32, the physical memory areas 142a, 142b, 142c, and 142d are assigned to the virtual memory areas 242b, 242c, 242d, and 242e, respectively. Herewith, data processed by each of applications corresponding to the virtual memory areas 242b, 242c, 242d, and 242e is passed on to the next application.

On the other hand, the memory control unit 231 assigns not the physical memory area 142e but a physical memory area 142f newly secured in the RAM 112 to the virtual memory area 242a corresponding to the first application. In addition, the physical memory area 142e assigned, in State 31, to the virtual memory area 242e corresponding to the last application may be used for a different process and overwritten with data, or data stored in the physical memory area 142e may be directly used for a different process.

In addition, when State 32 is shifted to State 33, as for the physical memory areas 142a to 142c and 142f, the memory control unit 231 shifts the individual assignment destinations by one virtual memory area in the data passing direction. On the other hand, the memory control unit 231 assigns a new physical memory area 142g to the virtual memory area 242a.

FIG. 16 above illustrates the case of read access; however, in the case of write access, the assignment of the physical memory areas is implemented in the same manner, except for the physical memory areas being assigned in the reverse direction.

The procedure of the above-described modification is able to be implemented by changing the procedure of the second embodiment in the following manner. In the case when determining, in step S125, that all the applications have completed their data processing, the memory control unit 231 reassigns, in step S126, each of the physical memory areas assigned to the virtual memory areas corresponding to all the applications, except for the last application, to a virtual memory area corresponding to its next application. At the same time, the memory control unit 231 secures a new physical memory area and assigns the secured physical memory area to the virtual memory area corresponding to the first application. The memory control unit 231 updates the address conversion table 250 so that mappings between the virtual memory areas and the physical memory areas are changed in such a manner.

The operation of the memory area assignment according to the above-described modification also achieves the same effect as the second embodiment. Whether to select the memory area assignment according to the second embodiment or the modification may depend on, for example, processing content of the applications and involvement of other processes in the virtual machines 210 and 220.

Note that the processing functions of each of the apparatuses (the information processing apparatus 1 and the controller module 110) described in the embodiments above may be achieved by a computer. In this case, a program is made available in which processing details of the functions to be provided to each of the above-described apparatuses are described. By executing the program on the computer, the above-described processing functions are achieved on the computer. The program in which processing details are described may be recorded in a computer-readable recording medium. Such computer-readable recording media include a magnetic-storage device, an optical disk, a magneto-optical recording medium, and a semiconductor memory. Examples of the magnetic-storage device are a hard disk drive (HDD), a flexible disk (FD), and a magnetic tape. Example of the optical disk are a digital versatile disc (DVD), a DVD-RAM, a compact disc-read only memory (CD-ROM), a CD-recordable (CD-R), and a CD-rewritable (CD-RW). An example of the magneto-optical recording medium is a magneto-optical disk (MO).

In the case of distributing the program, for example, portable recording media, such as DVDs and CD-ROMs, in which the program is recorded are sold. In addition, the program may be stored in a memory device of a server computer and then transferred from the server computer to another computer via a network.

A computer for executing the program stores the program, which is originally recorded in a portable recording medium or transferred from the server computer, in its own memory device. Subsequently, the computer reads the program from its own memory device and performs processing according to the program. Note that the computer is able to read the program directly from the portable recording medium and perform processing according to the program. In addition, the computer is able to sequentially perform processing according to a received program each time such a program is transferred from the server computer connected via a network.

According to one aspect, it is possible to reduce the processing load accompanying data passing among a plurality of processes.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus on which a plurality of virtual machines run, the information processing apparatus comprising:
a memory that stores address information registering therein mappings between addresses of a plurality of virtual memory units individually referred to at execution of each of a plurality of, as many as three or more, processes and addresses of a plurality of physical memory areas each of which is assigned to one of the virtual memory units; and
a processor that performs a procedure including:
running a first virtual machine and a second virtual machine,
causing, in a condition where each of the physical memory areas is assigned to one of the virtual memory units based on the address information, each of the processes to be executed in parallel on one of the first virtual machine and the second virtual machine, the first virtual machine being caused to execute at least one of the processes and the second virtual machine being caused to execute at least another one of the processes, and
updating, based on ranks each assigned in advance to one of the processes, the address information in such a manner that an assignment destination of each of the physical memory areas currently assigned to one of the virtual memory units, except for a virtual memory unit corresponding to a last-rank process, is changed to a virtual memory unit corresponding to a next-rank process following a process corresponding to the virtual memory unit to which the physical memory area is currently assigned.

2. The information processing apparatus according to claim 1, wherein:
the updating includes updating the address information in such a manner that an assignment destination of a physical memory area currently assigned to the virtual memory unit corresponding to the last-rank process is changed to a virtual memory unit corresponding to a first-rank process.

3. The information processing apparatus according to claim 1, wherein:
the procedure further includes monitoring whether the execution of each of the processes is completed, and
the updating is performed when the execution of all the processes is completed.

4. The information processing apparatus according to claim 1, wherein:
the first virtual machine receives a first data write request requesting to write, to a storage apparatus, data based on a first block-by-block, and makes write access to the storage apparatus to write the data thereto, the first block-by-block being a data access unit used by the first virtual machine,
the second virtual machine receives a second data write request requesting to write data to the storage apparatus on a file-by-file basis, and makes write access to the storage apparatus to write the data thereto via the first virtual machine,
one of the at least another one of the processes executed by the second virtual machine is to pass, to the first virtual machine, the data requested by the second data write request to be written, and
one of the at least one of the processes executed by the first virtual machine is to convert the data passed from the second virtual machine from data based on a second block-by-block to data based on the first block-by-block, the second block-by-block being a data access unit used by the second virtual machine.

5. A memory management method comprising:
running, by a computer, a first virtual machine and a second virtual machine;
registering, by the computer, in address information stored in a memory, mappings between addresses of a plurality of virtual memory units individually referred to at execution of each of a plurality of, as many as three or more, processes and addresses of a plurality of physical memory areas each of which is assigned to one of the virtual memory units;
causing, by the computer, in a condition where each of the physical memory areas is assigned to one of the virtual memory units based on the address information, each of the processes to be executed in parallel on one of the first virtual machine and the second virtual machine, the first virtual machine being caused to execute at least one of the processes and the second virtual machine being caused to execute at least another one of the processes; and
updating, by the computer, based on ranks each assigned in advance to one of the processes, the address information in such a manner that an assignment destination of each of the physical memory areas currently assigned to one of the virtual memory units, except for a virtual memory unit corresponding to a last-rank process, is changed to a virtual memory unit corresponding to a next-rank process following a process corresponding to the virtual memory unit to which the physical memory area is currently assigned.

6. A non-transitory computer-readable storage medium storing a memory management program that causes a computer to perform a procedure comprising:
running a first virtual machine and a second virtual machine;
registering, in address information stored in a memory, mappings between addresses of a plurality of virtual memory units individually referred to at execution of each of a plurality of, as many as three or more, processes and addresses of a plurality of physical memory areas each of which is assigned to one of the virtual memory units;
causing, in a condition where each of the physical memory areas is assigned to one of the virtual memory units based on the address information, each of the processes to be executed in parallel on one of the first virtual machine and the second virtual machine, the first virtual machine being caused to execute at least one of the processes and the second virtual machine being caused to execute at least another one of the processes; and
updating, based on ranks each assigned in advance to one of the processes, the address information in such a manner that an assignment destination of each of the physical memory areas currently assigned to one of the virtual memory units, except for a virtual memory unit corresponding to a last-rank process, is changed to a virtual memory unit corresponding to a next-rank process following a process corresponding to the virtual memory unit to which the physical memory area is currently assigned.
